(19) United States
(12) Patent Application Publication
(10) Pub. No.: US 2006/0229757 A1
(43) Pub. Date: Oct. 12, 2006

(54) Part selection aiding system

(76) Inventors: Shunsuke Minami, Mito (JP); Tomotoshi Ishida, Hitachinaka (JP); Shinya Yuda, Hitachi (JP)

Correspondence Address: DICKSTEIN SHAPIRO LLP, 1825 EYE STREET NW, Washington, DC, 20006-5403, US

(21) Appl. No.: 11/447,927

(22) Filed: Jun. 7, 2006

Related U.S. Application Data
(63) Continuation of application No. 10/777,753, filed on Feb. 13, 2004.
Application No. 10/777,753 is a continuation of application No. 10/173,018, filed on Jun. 18, 2002, now abandoned.

(30) Foreign Application Priority Data
Oct. 5, 2001 (JP) 2001-309893

(51) Int. Cl. G06F 19/00

(52) U.S. Cl. 700/107; 700/95

(57) ABSTRACT

A method and a system are adapted for easily finding out parts having compatibility to desired parts. The system stores product construction and classification of parts for reading out product construction data and displaying a list of parts forming a product or a partial assembly input by an operator, and reading out information relating to classification of the parts, displaying tree form according to hierarchy of classification and displaying a list of parts of the same classification of as designated parts or partial assembly by displaying tree form in hierarchy of classification. A display data including a switching command for switching to a part classification display screen image including individual parts together with the list of parts is generated.

### BACKGROUND OF THE INVENTION

The present invention relates to a method of selecting parts from a parts database storing information of parts, a system supporting the same, a support program and a storage medium storing the support program.

In designing of machine products or electronic circuit board, it becomes necessary to replace existing parts or unit with new parts or unit.

On the other hand, upon obtaining electronic parts or so forth, it becomes necessary to retrieve compatible parts which satisfies specification designated by a design division based on price, supply amount, delivery date, and to obtain the parts from a plurality of makers for distributing obtainment risk.

In the foregoing case, it becomes necessary to check parts of the same kind as the currently used parts and to compare specification, price, purchase condition.

Conventionally, it is typical to select necessary parts from brochure collecting the same kinds of parts. Upon retrieving parts having compatibility to the existing parts, retrieval is performed on a parts list of the product and specifications of the parts are checked to find the parts adapted thereto. Furthermore, check is performed whether the parts or the parts of the same kind produced by the same manufacturer is used in the existing product to unitarily make judgment for production, use, obtainment, technical performance and so forth for selecting the parts.

As prior art supporting such operation, there is an invention disclosed in Japanese Patent Application Laid-Open No. 2000-339381. In the publication, there has been disclosed a method for producing a display data embedded a display button for a product construction reverse tree in a product construction normally developed tree image. By this, it can be easily known at which portion, the particular parts forming the product is used in another product by the reverse developed tree.

As another prior art, there is a matrix parts table as disclosed in Japanese Patent Application Laid-Open No. 2000-148814. In the shown technology, the compatible parts of series products are displayed together with the matrix form parts table in side-by-side relationship to see difference of component parts in the series products.

In the prior arts, while parts constructions of the products can be easily listed, it is required to retrieve parts adapted to specification value from brochure of parts separately when the same kind of parts is to be found. On the other hand, when desired parts is found, in order to check whether the found parts is used in the existing products, it becomes necessary to return to the parts construction retrieval system to check the parts construction of the products again.

On the other hand, in the prior art disclosed in Japanese Patent Application Laid-Open No. 2000-339381, since there is no method for retrieving compatible parts of the designated parts, it becomes necessary to perform retrieval of the compatible parts by a retrieval product independent of the construction tree retrieving program.

Furthermore, in the prior art disclosed in Japanese Patent Application Laid-Open No. 2000-148814, in the series products, it can only recognized difference of parts construction and cannot find parts in the matrix form parts table compatible with the designated parts. Furthermore, for the parts used in products other than series product, retrieval cannot be extended even when parts have compatibility to the designated parts.

### SUMMARY OF THE INVENTION

The present invention has been worked out in view of the drawbacks in the prior art set forth above. Therefore, it is an object of the present invention to provide a method and a system for easily finding out parts having compatibility to a desired parts.

Another object of the present invention is to provide a method and a system for easily retrieving document showing information relating to record and association of products employing compatible parts.

According to the first aspect of the present invention, a parts selection supporting system comprises:

display means;

product construction storage means for storing product construction;

parts classification storage means for storing classification of parts;

construction display data generation means for reading out product construction data from the product construction storage means and displaying a list of parts forming a product or a partial assembly input by an operator, and

parts classification display data generation means for reading out information relating to classification of the parts from the parts classification storage means, displaying tree form according to hierarchy of classification and displaying a list of parts of the same classification of as designated parts or partial assembly by displaying tree form in hierarchy of classification on the display means,

the construction display data generating means generating a display data including a switching command for switching to a part classification display screen image including individual parts together with the list of parts.

In the preferred construction, the parts selection support system may further comprise:

product construction reverse tree display data generating means for displaying upper level assembly and/or product using designated parts or assembly in tree form, and

the parts classification display data generating means generates the display data including a switching command for switching to a product construction reverse tree display screen image designating each parts.

The parts selection support system may further comprise:

parts data storage means for storing parts information; and

data taking means for reading data from the parts data storage means and updating or adding data of the parts classification storage means.

According to the second aspect of the present invention, a parts selection supporting method comprises:

construction display data generation step of reading out product construction data from product construction storage means storing parts construction of a product and displaying a list of parts forming the product or a partial assembly input by an operator;

parts classification display data generation step of reading out classification of parts of parts classification storage means for storing information relating to classification of parts for displaying in tree form and displaying a list of the parts in the same classification,

in the construction display data generation step, a display data including a switching command to the parts classification display screen image including individual parts together with a list of the parts.

The parts selection supporting method may further comprise:

product construction reverse tree display data generating step of reading out the product construction data from the product construction storage means and displaying upper level assembly and/or product using designated parts or assembly in tree form,

in the parts classification display data generating step, a display data including switching command for switching to a product construction reverse tree display screen image designating each parts.

The parts selection support means may further comprise a step of reading out parts data from parts data storage means storing parts information, and updating or adding data of the parts classification storage means.

According to the third aspect of the present invention, a computer readable storage medium storing a program supporting selection of parts on the basis of data relating to product or parts stored in database, the program comprising:

construction display data generation step of reading out product construction data from product construction storage means storing parts construction of a product and displaying a list of parts forming the product or a partial assembly input by an operator;

parts classification display data generation step of reading out classification of parts of parts classification storage means for storing information relating to classification of parts for displaying in tree form and displaying a list of the parts in the same classification,

in the construction display data generation step, a display data including a switching command to the parts classification display screen image including individual parts together with a list of the parts.

The program may further comprise:

product construction reverse tree display data generating step of reading out the product construction data from the product construction storage means and displaying upper level assembly and/or product using designated parts or assembly in tree form,

in the parts classification display data generating step, a display data including switching command for switching to a product construction reverse tree display screen image designating each parts.

The program may further comprise a step of reading out parts data from parts data storage means storing parts information, and updating or adding data of the parts classification storage means.

According to the fourth aspect of the present invention, a parts selection supporting program to be executed by a computer, comprises:

construction display data generation step of reading out product construction data from product construction storage means storing parts construction of a product and displaying a list of parts forming the product or a partial assembly input by an operator;

parts classification display data generation step of reading out classification of parts of parts classification storage means for storing information relating to classification of parts for displaying in tree form and displaying a list of the parts in the same classification,

in the construction display data generation step, a display data including a switching command to the parts classification display screen image including individual parts together with a list of the parts.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a schematic block diagram showing one embodiment of a parts selection support system according to the present invention;

FIG. 2 is an illustration showing a data structure in a product construction database;

FIG. 3 is an illustration showing a data structure of a parts classification database;

FIG. 4 is an illustration showing a data structure of a parts database;

FIG. 5 is a flowchart showing one example of a process of a product construction screen generation program;

FIG. 6 is an explanatory illustration showing an example of display of a product construction screen;

FIG. 7 is a flowchart showing one example of a process of a parts classification reverse development tree screen generation program;

FIG. 8 is an illustration showing an example of display of a classification reverse development tree screen;

FIG. 9 is an illustration showing an example of display of a parts classification screen;

FIG. 10 is a flowchart showing one example of a process of a parts classification screen generation program;

FIG. 11 is a flowchart showing one example of a process of a product construction reverse tree screen generation program;

FIG. 12 is an illustration showing an example of display of a product construction reverse tree screen;

FIG. 13 is an illustration showing an example of a product construction tree screen;

FIG. 14 is a flowchart showing a process of the same kind classification display of one hierarchal level;

FIG. 15 is an illustration of an example of display of a classification screen of one hierarchal level including a designated parts;

FIG. 16 is a schematic block diagram showing a computer system to be employed for implementing the present invention;

FIG. 17 is a schematic block diagram showing another construction of a computer system for implementing the present invention;

FIG. 18 is a schematic block diagram of another embodiment of a parts selection support system according to the present invention;

FIG. 19 is an illustration of a data structure of an external parts database;

FIG. 20 is an illustration of a data structure of a classification correspondence table;

FIG. 21 is a flowchart showing one example of a process of data acquiring means;

FIG. 22 is an illustration showing another data structure of parts database; and

FIG. 23 is an illustration showing an example of display of a parts classification screen, on which new parts is displayed.

### DESCRIPTION OF THE PREFERRED EMBODIMENTS

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

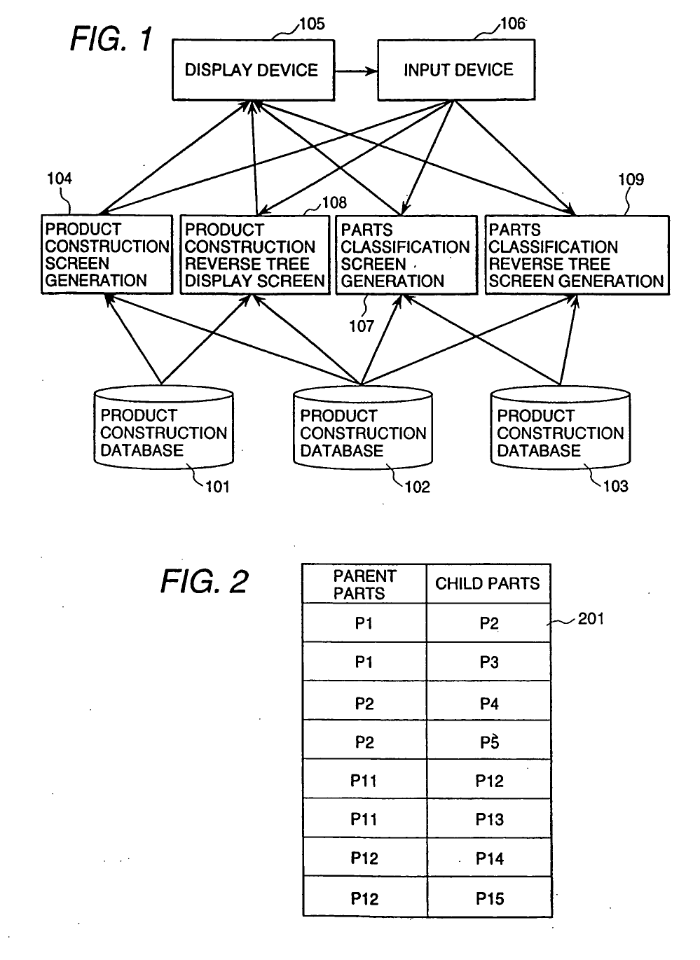

FIG. 1 shows one embodiment of a part selection support system according to the present invention. A product construction database 101 as an embodiment of product construction storage means of the present invention stores information of hierarchal relationship of parts forming the product. A parts database 102 as embodiment of parts data storage means of the present invention, stores parts name and/or attribute of each individual parts. A parts classification database 103 stores classification data of parts of the same kind in hierarchy.

A construction display data generation means of the present invention is realized by a product construction screen generation program 104. The product construction screen generation program 104 takes out a hierarchal relationship of the parts designated by an input device 106 from the product construction database 101 and further takes out parts data of the relevant parts from the parts database 102 to generate a product construction display screen image as data for displaying buttons including parts classification display screen image corresponding to respective parts numbers together with parts attributes such as parts number, parts name and so forth, according to a hierarchal relationship, for displaying on a display device 105.

An input device 106 reads out position information of a display data on the product construction display screen image displayed on the display device 105, and calls a parts classification screen generation program 107 according to a command of a parts classification display screen image generation button as designated by a pointing device, such as mouse or the like.

The parts classification display data generation means of the present invention is realized by the parts classification screen generation program 107. In the process of the parts classification screen generation program 107, the classification data including the parts having parts number corresponding to the button designated by the parts classification display data generation means of the present invention is read out from the parts classification database 103, and an attribute information, such as parts name or the like from the parts database 102 is read out in order to display a parts classification display screen image generated buttons including instruction for calling a product construction reverse tree display screen generation program 108 for displaying the parts number, the parts name and the product in which respective parts are used so as to display the parts classification display screen image on the display device 105.

The input means read out position information of the display data on the parts classification display screen image displayed on the display device 105 and calls the product construction reverse tree display screen program 108 in response to a command input through the button for generating the product construction reverse tree display screen image of the parts designated by a pointing device, such as mouse or the like.

The product construction reverse tree display data generation means according to the present invention is realized by the product construction reverse tree display screen generating program 108. The product construction reverse tree display screen generation program 108 reads out the construction data of the parts designated through the input device 106 from the product construction data base 101 and retrieves the parts belonging in the upper hierarchal level of the parts designated through the input device 106 together with the parts name read out from the parts database 102, for displaying the product construction reverse tree display screen image showing construction up to the product at the highest level.

The parts classification reverse tree display screen generation program 109 reads out the classification data of the parts designated by the input device 106 from the parts classification database 103, retrieves the parts in upper classification hierarchal level in which the parts designated by the input device 106 belongs, and displays a parts classification reverse tree display screen image showing a product classification reverse tree up to a class of the highest hierarchal level.

FIG. 2 shows a product construction database. In the product construction database 101, a relationship between parent parts and child parts of the product is stored. For example, a record 201 shows that a parts of a parts number P1 includes a parts of parts number P2.

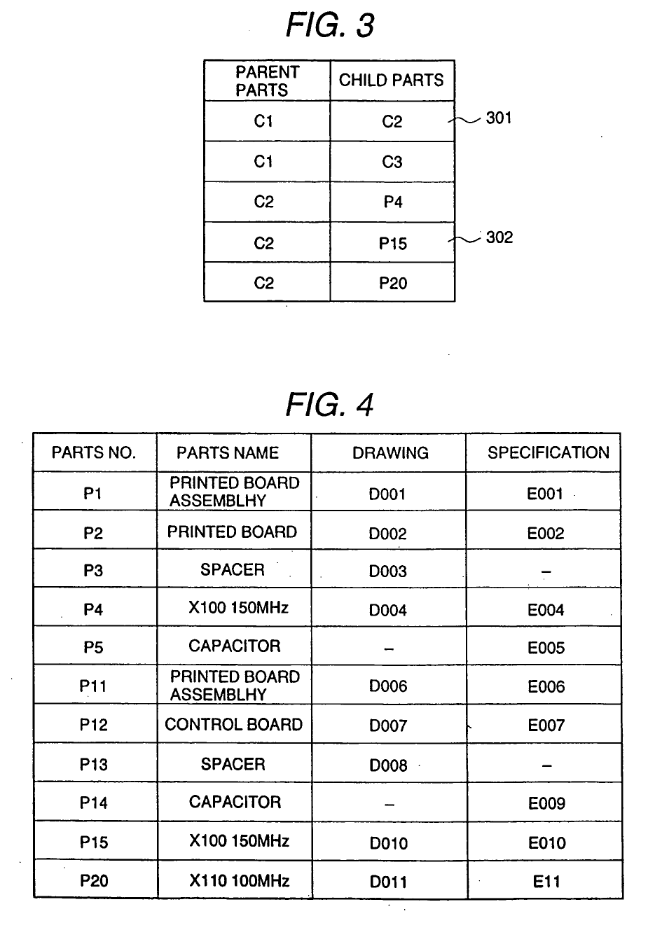

FIG. 3 shows a parts classification database. In the parts classification database 103, a relationship between parent classification and child classification of the parts is stored. For example, a record 301 shows that a class C2 is included in a class C1. On the other hand, a record 302 shows that a parts P15 is contained in the class C2.

FIG. 4 shows a parts database. In the parts database 102, data of individual parts is stored. Data of the parts is an attribute information, such as parts number and parts name, for example. While the parts name, drawing number, design document number are stored as the attribute information in the embodiment shown in FIG. 4, the attribute information may contain data, such as weight, supplier to purchase, price and so forth. On the other hand, a suggestion-book in production, claims from user, failure report and so forth may also be contained in the attribute information.

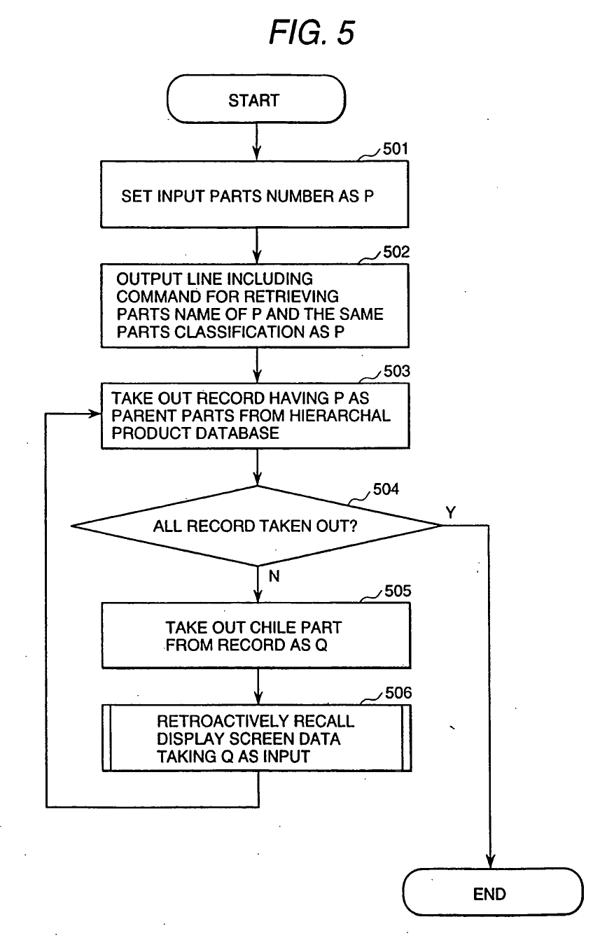

FIG. 5 shows a process of a product construction screen generating program. The product construction screen generation program 104 generates a product construction display screen image for displaying a construction display screen image on the display device 105. Here, it is assumed that an input parts number is assumed as P (501). Next, the parts database is retrieved to take out a parts attribute, such as parts name, corresponding to the parts number P to add in the display data. Furthermore, a retrieval command is added to the display data for calling the parts number as input for the parts classification generation program for generating the parts classification display screen image including the parts classification of the same kind as the parts number P (502).

Next, the product construction database 101 is retrieved to take out a record which includes the parts number P as parent parts (503). Then, judgment is made whether all of child parts of the parts number P are taken out (504). When no child parts is present or all of the child parts are taken out, execution of the program goes end. On the other hand, when newly taken out record is present, a column of the child parts of the newly taken out record is made reference to set the parts number of the child parts as Q (505). Next, with taking the parts number Q, the shown product construction screen generation program is called recursively to return the process to step 503 to take out the record of the child parts of the parts number P (506).

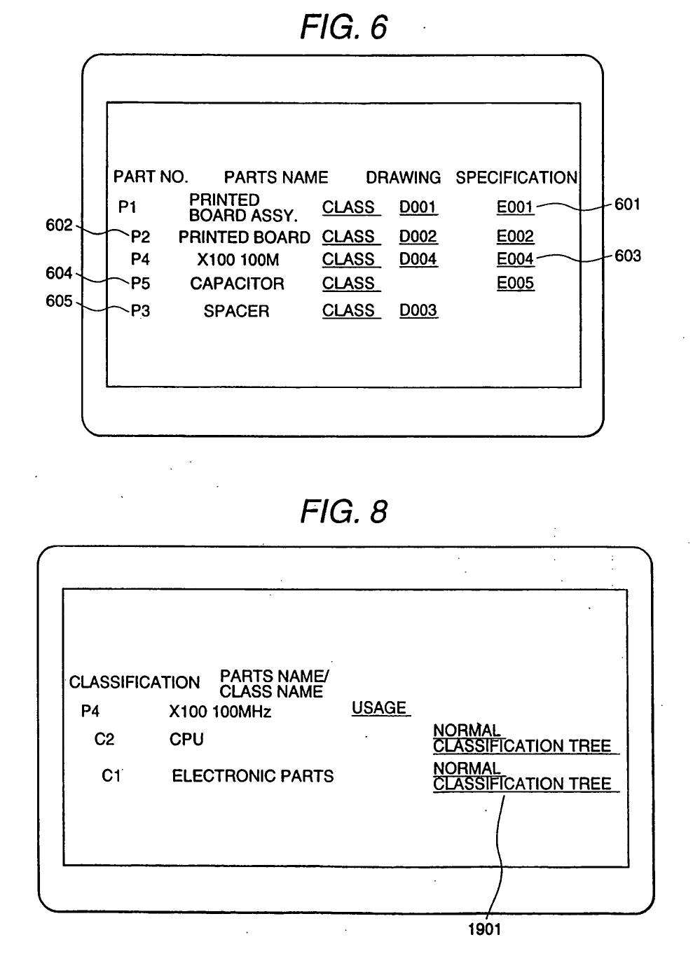

FIG. 6 shows an example of the product construction display screen image. The example shown in FIG. 6 shows the display screen data generated by the parts construction screen generating program 104. The first column of the display screen image shows the parts number. So as to facilitate understanding of the hierarchal relationship, the child parts is displayed with offset toward right from the parent parts for one stage. The second column shows the parts attribute data, such as parts name or the like. The parts attribute data is read out from the parts database 102 as set forth above. When a button labeled as “CLASS” in the third column, is depressed, the parts classification screen generation program 107listing the same kinds of parts as respective parts is actuated for displaying the list on the display device 105.

Operation of the parts construction screen generation program of FIG. 5 will be discussed particularly in terms of generation of the display screen image of FIG. 6. A user inputs the parts number P1 desired to display the product construction to actuate the product construction screen generating program. At step 501, P1 is set in the parameter P. At step 502, one line consisted of the parts number P1, the parts name “printed board assembly”, a button “CLASS” for switching to a class hierarchy display screen image including P1, a link “D001” for switching the display to the display screen image D001 of P1, and a button “E001” for opening the display screen image of a specification E001 of P1. The links for switching display to the screen or the specification is generated with reference to the parts database of FIG. 4.

Next, among the records of the child parts P2, P3 of the parts number P1, the record of P2 is taken out at step 503. In judgment at step 504, the process is branched to the side of “N” since the record of the parts number P2 is taken out. Then, at step 505, the parts number P2 is taken out from the taken out record of P2 to replace for the parameter Q. Then, with taking the parameter Q, namely P2, the generation process is called in recursive manner.

When the process of FIG. 5 is called with taking Ps as input, the line of 602 of FIG. 6 is displayed in similar manner as the case of P1 at step 502. Furthermore, at step 503, a record P4 of the child parts of P2 is taken out. At step 506, the process of FIG. 5 is called recursive manner with taking P4 as input. When the input is P4, a line 603 relating to P4 is output at step 502. At step 503, attempt is made to take out the record of the child parts of P4. However, since there is no record taking P4 as parent parts in the database of FIG. 2, the process is branched to the side “Y” to terminate recursive process taking P4 as input.

When the process at step 506 taking P4 as the parameter Q is completed, the process returns to step 503 to take put the record of another child parts P5 of the parts P2 to output a line 604 through the recursive process in the similar manner as the case of P4. Thereafter, the process returns to step 503. Since records taking the parts P2 as parent are only child parts P4 and P5, all records have already been taken out to branch to “Y” to terminate the process taking P2 as input P and then pass step 506 in recursive level taking P2 as input P.

When the input P is P1, another record taking P3 as child parts is left in the parts construction database of FIG. 2. Then, through step 506 taking P3 as Q, the process of FIG. 5 is recursively called to obtain a line 605.

As set forth above, by the product construction screen generation process of FIG. 5 as set forth above, data for the display screen image of FIG. 6 is generated.

Since the list can be easily switched from the list of the parts forming the product the list of the parts of the same kind by the product construction display screen image generated through the process shown in FIG. 5 set forth above, it facilitates retrieval of replacement parts.

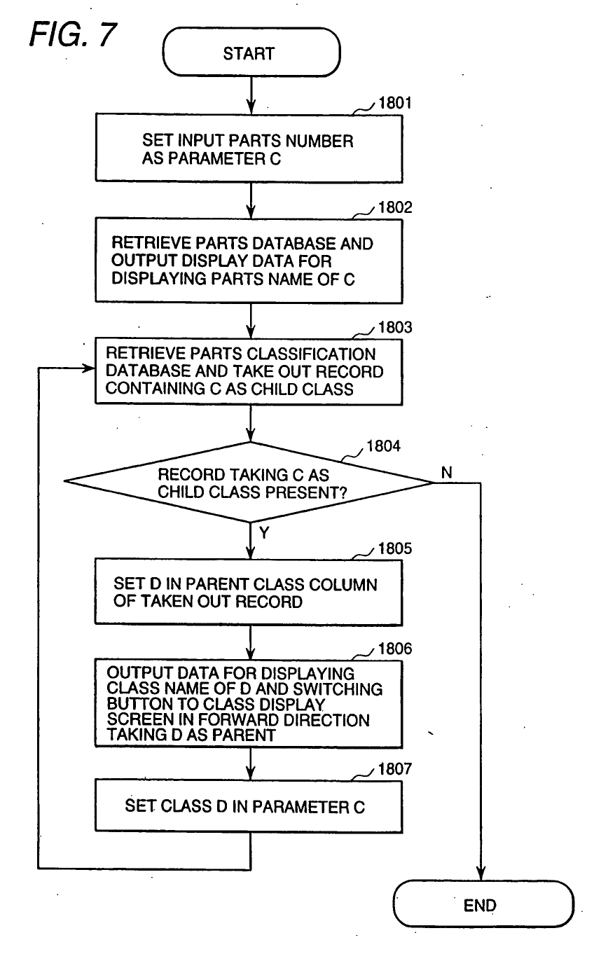

A process of a parts classification reverse development tree screen generation program 109 is shown in FIG. 7. At first, the input parts number is stored in the parameter C (1801). next, the parts database is retrieved to output a display data for displaying the parts name of C (1802). Thereafter, the parts database is retrieved to sequentially take out the records taking C as child classification (1803). If there is no record, child classification of which is C, namely the highest level classification (1804), the program is terminated.

On the other hand, if the record of C as child classification is taken out from the parts classification database, the process is advanced to step 1805. At step 1805, the parent classification of the taken out record is set as D. Then, at step 1806, a line consisted of the class name of D, parts classification in forward or normal direction with taking D as parent classification, namely from the parent classification to the child classification, and a button for switching display, is output. Finally, the parameter C is set as parameter D, namely the parent classification is set C (1807). Then, the process from step 1803 and subsequent steps are repeated.

FIG. 8 shows a classification reverse development tree screen. A tree structure from the parts to upper classification is generated to obtain the classification reverse development tree display screen image. By this, it can be easily known the classification in which the designated parts belongs. On the other hand, by a bottom of normal classification tree, a list of the parts of the same kind at the level required by the user, can be obtained.

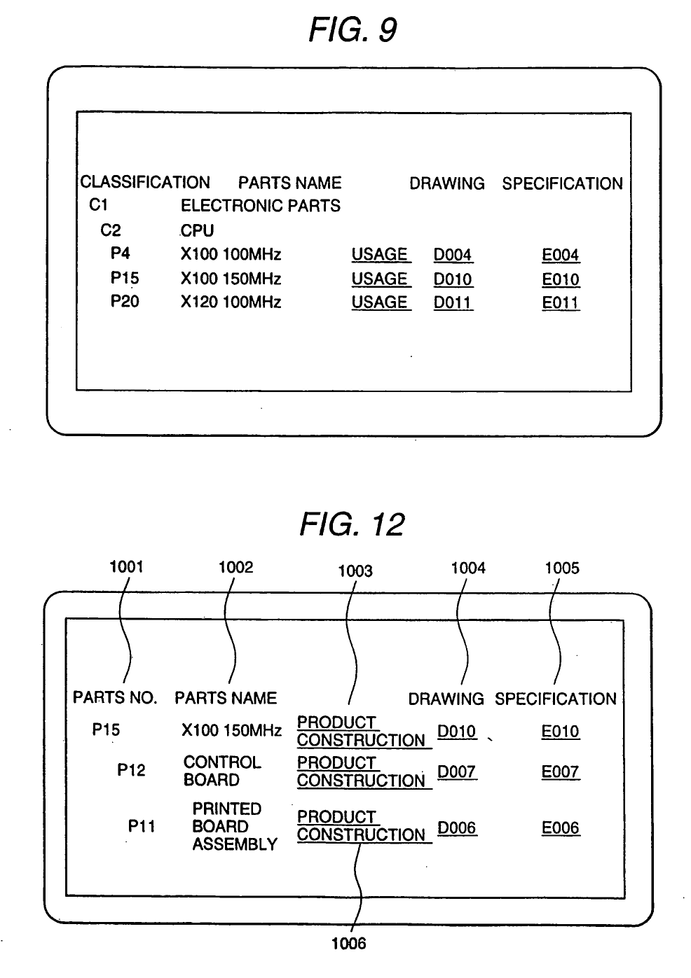

When the normal classification tree button on the display screen image of FIG. 8 is depressed, the normal development tree display screen image of the parts classification taking the classification of the line at the peak. For example, when the “normal classification tree” button 1901 of the classification C1 of FIG. 8 is depressed, the parts classification taking C1 as peak as shown in FIG. 9 is displayed. As can be seen from FIG. 9, it can be seen that the same kind of parts as the initially focused parts P4 are P15 and P20 in addition to P4.

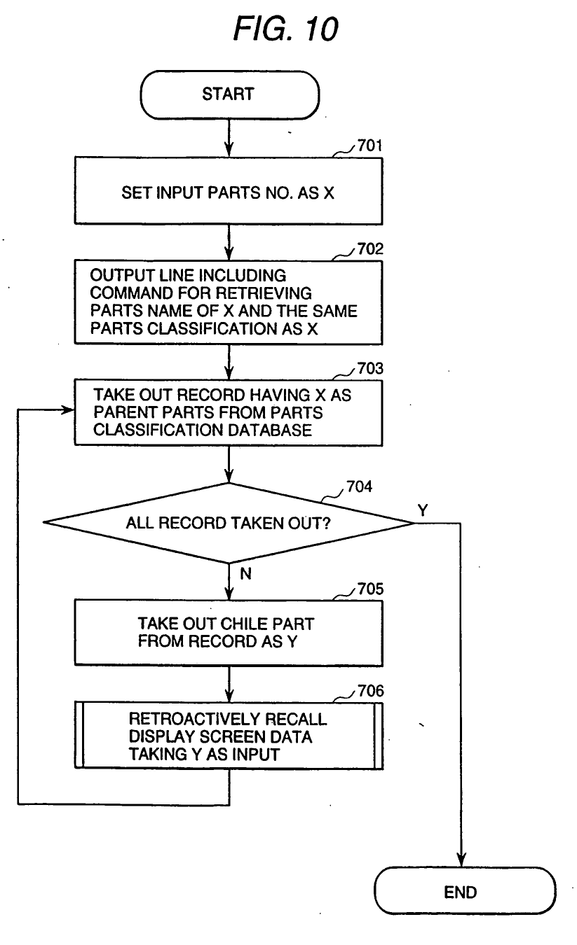

FIG. 10 shows a process of a part classification screen generation program. By the process of the parts classification screen generation program 107, a parts classification display screen image (FIG. 9) from the upper level parts to end level parts is generated and displayed on the display means 105.

Initially, the parts number X is input (701). Then, the parts database of FIG. 4 is retrieved to take out the parts attribute, such as the parts name, corresponding to the parts number X, to add to the display data. Furthermore, for generating the display screen image for displaying reverse development tree of the products using the parts number X, a retrieval command for calling the parts number as input of the product construction reverse tree display screen generation program 108, is added to the display data (702).

Next, the parts classification database 103 of FIG. 3 is retrieved to take out the records having X as the parent classification (703). When there is no record having X as the parent classification in the parts classification database, or when all records are processed at steps 705 and 706, the process is advanced to a branch Y to end the process. On the other hand, when the record not yet output is remained, the process is advanced to a branch N to execute step 705. At step 705, a column of the child classification of the taken out record is made reference to set the classification number as Y (705).

Next, the parts classification screen generation program is recursively called with taking the classification number Y as input. Then, the process is returned to step 703 to take out the next record having X as the parent classification (706). Such recursive process is similar to the method discussed in connection with step 506 of FIG. 5.

Finally, judgment is made whether all records having the classification number X as parent classification are output. If there are remained records, the process is returned to step 703. On the other hand, when the display data of all records are output, the execution of the program goes end (706).

The parts classification display screen image generated by the parts classification screen generation program 107 shows the classification number and parts number in the first column of the display screen image as shown in FIG. 9. So as to easily see the hierarchal relationship, the parts in the child classification is shown with offset toward right from the parent classification for one stage. In the second column, the parts attribute data, such as parts name or the like is displayed. As set forth above, the parts attribute data is read out from the parts database 102. When a button labeled “USAGE” in the third column is depressed, the product construction reverse tree screen generation program 108 is actuated for displaying the product construction reverse tree tracing the construction of the product using respective parts in reverse direction. Then, the generated display screen image data is displayed on the display device 105.

By the parts classification display screen image generated as set forth above, it can be easily appreciated the products and portions where respective parts are used from the list of the same kinds of parts. Therefore, it can be facilitated to retrieve information relating to the parts to be used as replacement.

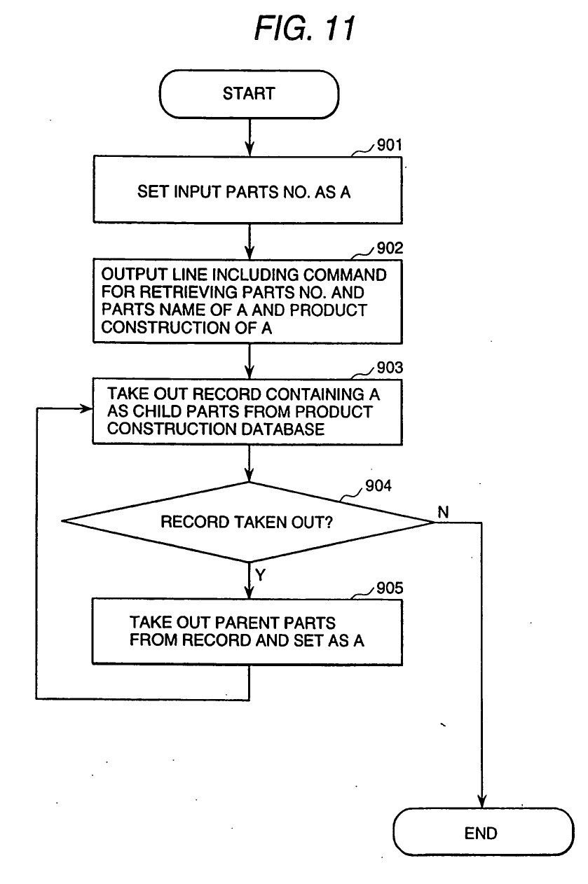

FIG. 11 shows a process of the product construction reverse tree display screen generating program. The product construction reverse tree display screen generating program 108 generates the display data of the product construction reverse tree display screen image for displaying the product construction reverse tree on the display device 105.

In the process shown in FIG. 11, at first, the parts number A is input (901). Next, the parts database is retrieved to take out the parts attribute, such as parts name, corresponding to the parts number A, to add to the display data. Furthermore, a retrieval command for calling the parts number A as input for the product construction screen generation program 104 is added to the display data (902) for generating the display screen image for displaying the classification of the parts A. next, the product construction database 101 is retrieved to take out the record having the parts number A as child parts.

Then, check is performed whether the records taking the parts A as child parts are taken out at step 903. If the record is not taken out, judgment is made that there is no parts in upper hierarchal level, namely that the parts is in the highest product construction. Thus, the process is advanced to a branch “N” to terminate the process. On the other hand, if the record is taken out, the parts number of the parent parts of the taken out record is set as A (step 905). Then, the process is retu8rned to step 902.

The first column 1001 in FIG. 12 shows the parts number. So as to facilitate understanding of the hierarchal relationship, the child parts is displayed with offset toward right from the parent parts for one stage. The second column shows the parts attribute data, such as parts name or the like. The parts attribute data is read out from the parts database 102 as set forth above.

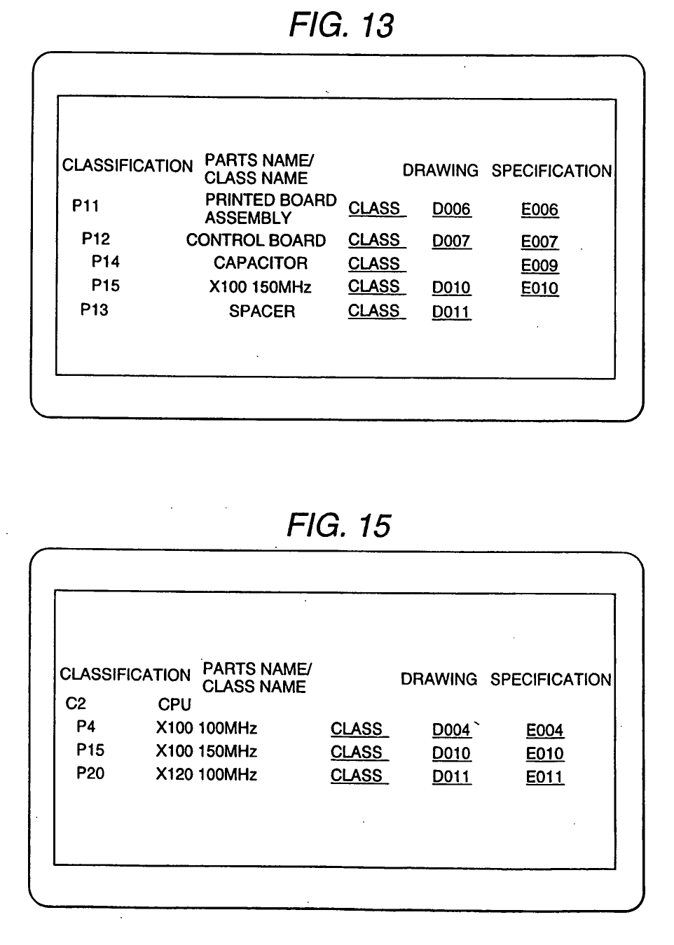

When the button displayed as “PRODUCT CONSTRUCTION” of the third column 1003, the product construction screen generation program 104 is actuated for displaying a list of parts forming the products. Them the generated display screen image data is displayed on the display device 105. For example, when the button of “PRODUCT CONSTRUCTION” of the parts P11 in FIG. 12 is depressed, the display screen is switched to show the product construction tree taking the parts P11 at the highest level as shown in FIG. 13.

The fourth column 1004 of FIG. 12 is a drawing number and a drawing data display button of respective parts. By pushing the button in the fourth column 1004, reference can be made to the drawings of respective parts or assembly. The fifth column 1005 shows a specification number and a specification display button when specifications of respective parts are present. When the button in the fifth column 1005 is depressed, the specifications of respective parts or assemblies are displayed.

By the product construction reverse tree display screen image generated through the foregoing process, it can be easily know the product and/or the portion of the product, in which the employed as replacement parts are used. By seeing the shape and specification value with reference to the drawing and/or specification of the upper level parts, target in design, such as use environment, use condition and so forth of the parts intended to employ can be appreciated.

Furthermore, by embedding the button for displaying respective product construction tree display screen image in the product construction reverse tree display screen image, it becomes possible to easily retrieve the parts to be used together with the parts to be employed as replacement parts.

Thus, it becomes possible to list not only the retrieved replacement parts but also the parts to be used together. Therefore, it becomes possible to easily retrieve candidates of the replacements parts required to be replaced in association with use of the replacement parts.

In the embodiment set forth above, in order to reach from the product construction display screen image of FIG. 6 to the construction reverse tree display screen image of FIG. 12 via the reverse classification tree display screen image of FIG. 8 and the normal or forward classification tree display screen image of FIG. 9, the screen generation process calling command is embedded to the display data of respective display screen image.

As another embodiment, it is possible to display the classification display screen image of one hierarchal level including the designated parts as shown in FIG. 15 from the product construction display screen image data of FIG. 6. By this, the same kind of parts can be retrieved skipping the reverse classification tree display screen image.

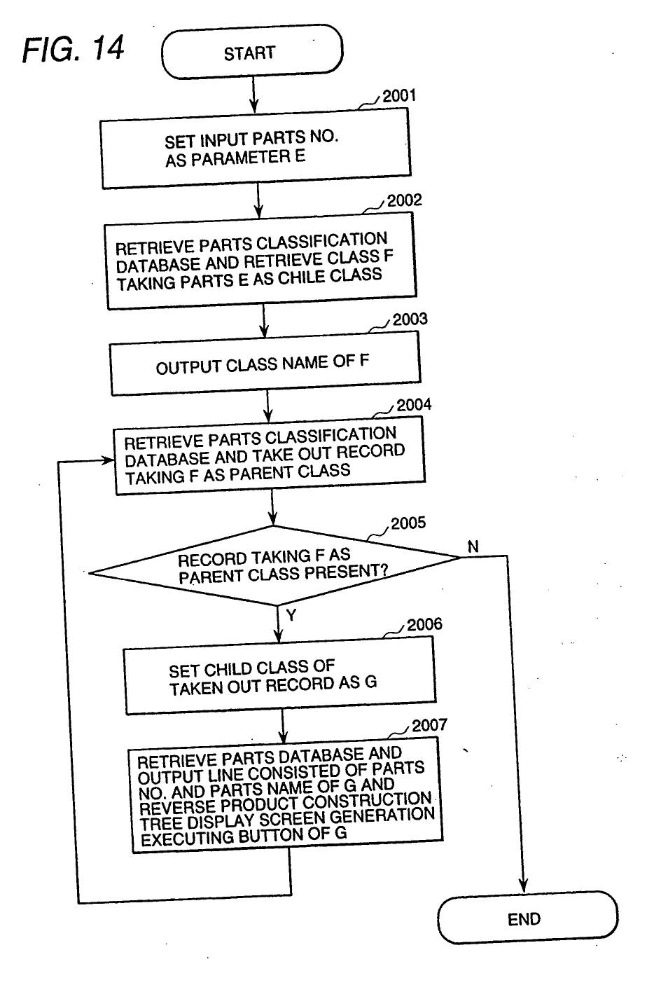

FIG. 14 shows a process for generating data for displaying the same kind of class in one hierarchal level, and FIG. 15 shows a parts classification display screen image of one hierarchal level.

The input parts number is set in a parameter E. When the display screen image of FIG. 15 is to be displayed, P4 is set in E (2001). Next, the parts classification database is retrieved to find the record taking the parts E as child classification and set the classification number in the column of the parent classification as F (2002). In the example of FIG. 15, the record of (C2, P4) is found to set C2 in F. Here, the classification name of F is displayed (2003).

At step 2004, the parts classification database is retrieved to take out the record taking F as parent classification. In case of FIG. 15, since C2 is set in F, there are (C2, P4), (C2, P15), (C2, P20). Amongst, the first one (C2, P4) is taken out. At step 2005, when the record is not found or all record are already taken out, the process is advanced to a branch “N” and then goes end. When the record is remained, the process is advanced to step 2006 to set the child classification of the taken out record as G.

In the example of FIG. 15, P4 is set in G. At step 2007, on the basis of result of retrieval of the parts database, the parts number, the parts name, the document number, such as the drawing, specification or the like, a link for display and a button for calling the construction reverse tree screen program shown in FIG. 11 are output Then, returning to step 2004, the next records (C2, P15), (C2, P20) are taken out in sequential order to output the corresponding line to generate the display data for displaying the parts classification display screen image as shown in FIG. 15.

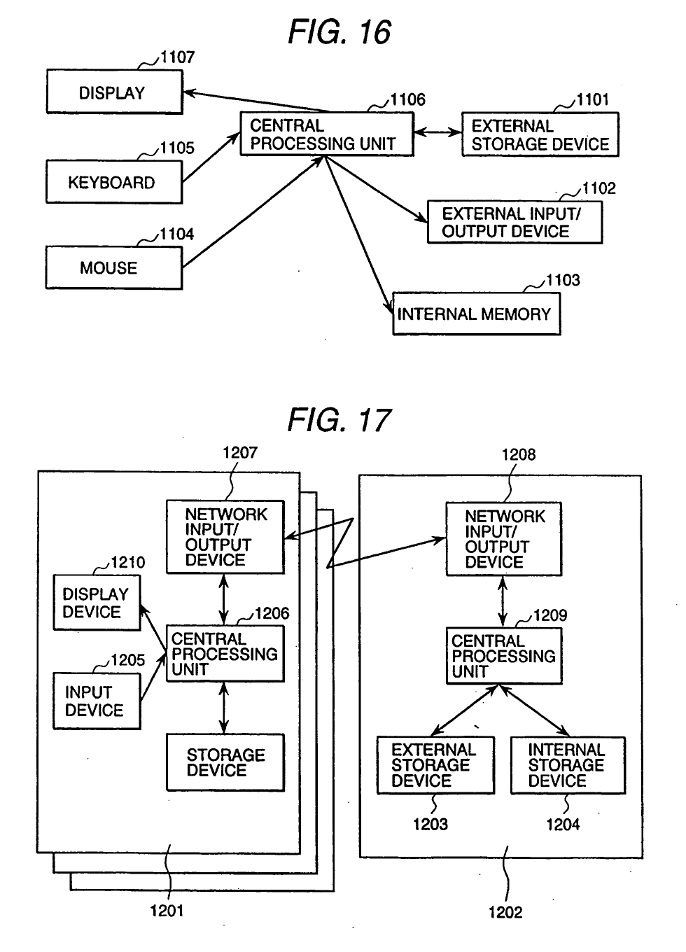

FIG. 16 shows a construction of a computer system for implementing the present invention. A program of the present invention is read out from an external storage device 1101 or from an external input/output device 1102, such as that connected through a network or the like, and is temporarily stored in an internal memory 1103. By a command of an operator input through a keyboard 1104 or a mouse 1105, the program stored in the internal memory 1103 is executed by a central processing unit 1106 for displaying the result on a display unit 1107. The product construction database 101, the parts classification database 103 and the parts database 102 are stored in the external storage device 1101.

FIG. 17 shows another construction of the computer system to be employed for implementing the present invention. In the shown embodiment, the system is constructed with a plurality of client computers 1201 and a server computer 1202. The shown embodiment of the program is read from the external storage device 1203 on the side of the server computer 1202 and is temporarily stored in the internal storage device 1204. From the input device 1205 of the client computer 1201, command of the operator is received from the input device 1205 of the client computer 1201 and is fed to the central processing unit 1209 on the side of server via the central processing unit 1206, network input/output devices 1207 and 1208 for running the program according to the present invention. Then, a display data generated by the program is fed to the client computer 1201 which fed the command via the network for displaying the resultant display data on the display means 1210 on the side of the client.

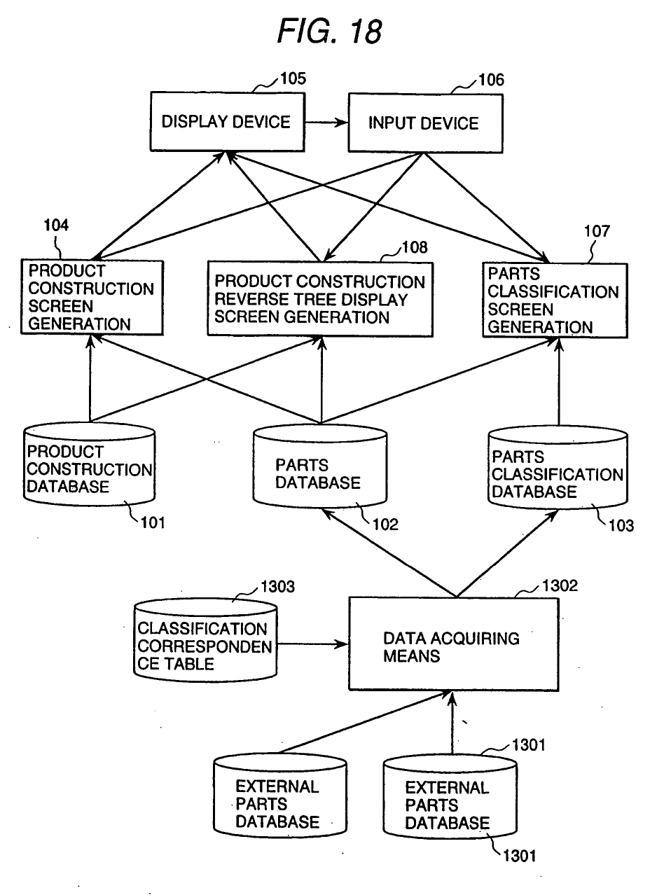

Next, another embodiment of the present invention will be discussed. FIG. 18 shows a construction, in which one or more external parts databases 1301, data taking means 1302 and classification correspondence table 1303 are added to a construction of the parts selection support system of FIG. 1.

The external parts database 1301 is a database to be managed the purchasing parts by manufacturer or intermediate agent. The data taking means 1302 is actuated regularly or in response to command of the operator to read the parts data and the classification data from the external parts database 1301 to add data in the parts database 102 and the parts classification database 103.

The classification correspondence table 1303 is made reference to when the data taking means 1302 replaces class identification code with the internal parts classification code if the classification identification code of the parts stored in the external parts database 1301 does not match with the parts classification code stored in the parts classification database 103. Accordingly, the classification correspondence table 1303 stores the correspondence table of the external classification identification code and the internal pars classification code.

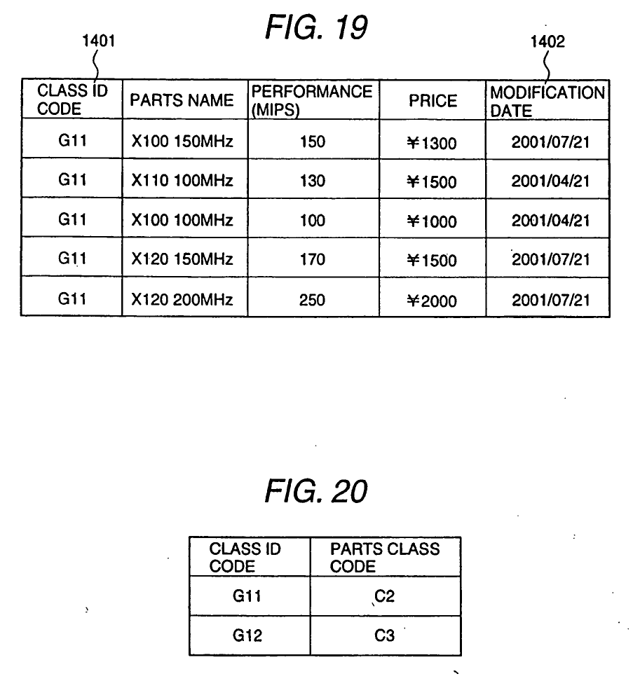

The external parts database 1301 stores data as shown in FIG. 19, for example. In the example of FIG. 19, since the classification identification code 1401 is different from the classification code of the parts classification database (FIG. 3), the classification correspondence table of the form shown in FIG. 20.

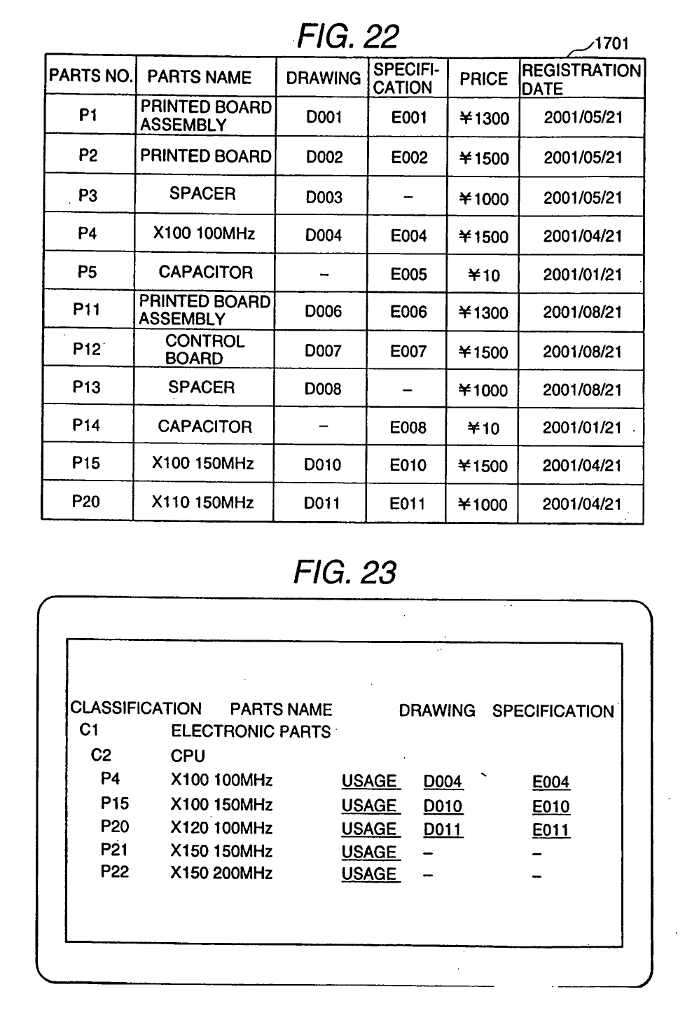

On the other hand, when an updating date data 1402 of FIG. 19 is added to respective parts data, the data taking means 1302 is actuated according to the updating date to maintain the information of the parts database 102 as latest information. Particularly, a column of a registration date 1701 as shown in FIG. 22 is provided in the parts database 102. Then, when the updating date 1402 is later than the registration date 1801, the data in the parts database is replaced with new data in the external parts database.

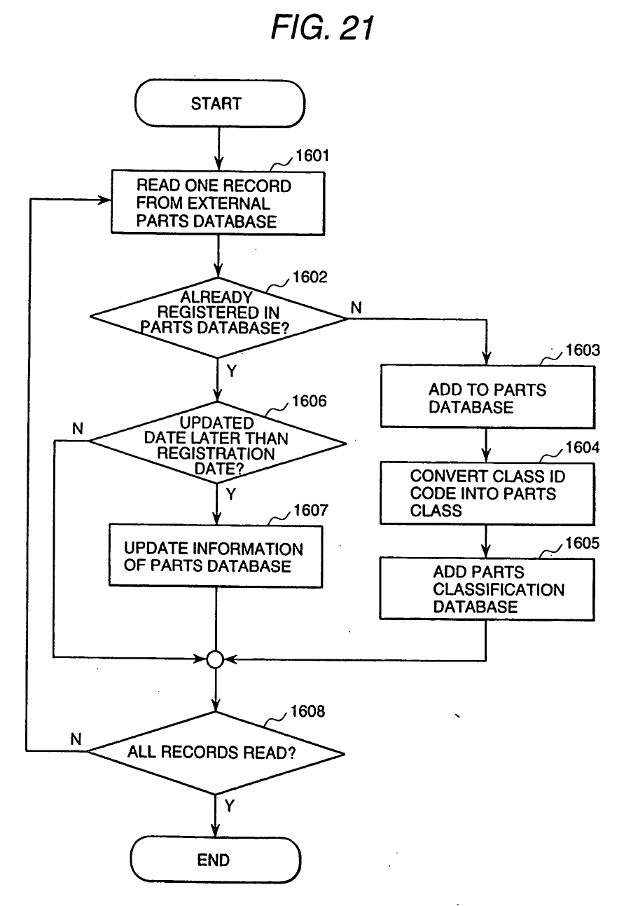

FIG. 21 shows a process procedure of the data taking means 1302. At first, the parts data of one record is read out from the external database (1601). Then, judgment is made whether the read one record of parts data has already been registered in the parts database 102 or not (1602). If not yet registered, the parts information is registered in the parts database (1603). Then, the classification identification codes of the external parts database 1301 are converted into the parts classification code of the parts classification database 103 according to the data of the classification correspondence table 1303 (1604). The converted parts classification code and the parts number are stored in the parts classification database 102 (1605).

When the data in the external parts database 1301 has already been registered in the parts database 102, then, the updating date and the registration date are compared (1606). If the updating date is later than the registration date, the information of the parts database 102 is updated with the parts information read from the external parts database 1301 to set the updating date (1607). The foregoing process is repeated for all of records of the external parts database 1301 (1608).

Through the foregoing process, the latest parts information is displayed on the parts classification data display screen image. For example, it is assumed that the parts classification data display screen image of FIG. 9 is the timing of Jun. 1, 2001. Similarly, when the classification button of the parts number P4 is clicked to display the parts classification data on Aug. 1, 2001 from the product construction display screen image of FIG. 6, the parts classification data display screen image is shown in FIG. 23. By the data taking means 1302, from the external parts database, since data updated on Jul. 21, 2001 is reflected in the parts classification database and the parts database, the parts classification screen generating means 107 displays data of parts P21 and P22 in comparison with the parts classification display screen image of FIG. 9.

Thus, since the latest parts data can be retrieved through the parts classification display screen image, it becomes possible to make reference to the parts data of the parts not yet used in the product. Since the latest parts are superior to the conventional parts in the price or performance, the replacement parts for improving performance or cost can be easily retrieved.

By the present invention, candidate of the replacement parts of the same kind can be easily retrieved from the existing product construction. Furthermore, by the present invention, record information, such as drawing, design specification, failure cases and so forth, necessary for study of the replacement parts, can be retrieved.

On the other hand, by the present invention, the latest parts information is taken from the external database and is displayed on the classification display screen image. Therefore, the replacement parts which can contribute for improvement of performance or cost can be easily retrieved.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1. A parts selection supporting system comprising:
display means;
product construction storage means for storing product construction; parts classification storage means for storing classification of parts;
construction display data generation means for reading out product construction data from said product construction storage means and displaying a list of parts forming a product or a partial assembly by displaying tree form in hierarchy of classification on said display means,
said construction display data generating means generating a display data including a switching command for switching to a part classification display screen image including individual parts together with said list of parts.

2-10. (canceled)
